(19) United States
(12) Patent Application Publication
(10) Pub. No.: US 2025/0323437 A1
(43) Pub. Date: Oct. 16, 2025

(54) CONNECTOR ADAPTOR

(71) Applicant: F TIME TECHNOLOGY INDUSTRIAL CO., LTD., NEW TAIPEI CITY (TW)

(72) Inventors: CHIEN-CHANG HUANG, NEW TAIPEI CITY (TW); CHANG-LIN PENG, NEW TAIPEI CITY (TW)

(21) Appl. No.: 18/636,533

(22) Filed: Apr. 16, 2024

(51) Int. Cl. H01R 12/72; H01R 13/22; H01R 13/621; H01R 13/629

(52) U.S. Cl. CPC H01R 12/722; H01R 13/22; H01R 13/6215; H01R 13/629

(57) ABSTRACT

A connector adaptor electrically connects to a circuit board and has a first assembly, a second assembly, and multiple fixture elements. The first assembly has a first center pin assembly and a retaining structure. The second assembly has a second center pin assembly and a first slot. The first center pin assembly is mounted through the first assembly. The second center pin assembly is mounted through the second assembly, and electrically connects to the first center pin assembly. The retaining structure is seated in the first slot. The first assembly and the second assembly form a concave-convex engaging relationship, thus limiting the first assembly from translating relative to the second assembly. When the first assembly and the second assembly are fastened by screws, the concave-convex engaging relationship prevents the two center pin assemblies from being pushed out due to uneven force.

### BACKGROUND OF THE INVENTION

### 1. Field of the Invention

The present invention relates to a connector adaptor adapted to be electrically connected to a circuit board.

### 2. Description of the Prior Arts

With reference to FIG. 9, with the flourishing of the communications industry, electronic products continue to strive for better transmission quality and timeliness, as well as offering a wide range of applications. A conventional connector adaptor comprises a first assembly 91, a second assembly 92 and multiple screws 93. The first assembly 91 comprises a first center pin assembly 911 and a first contact surface 912. The first center pin assembly 911 is mounted through the first assembly 91. The second assembly 92 comprises a second center pin assembly 921 and a second contact surface 922. The second center pin assembly 921 is mounted through the second assembly 92. The second contact surface 922 and the first contact surface 912 abut each other. The second center pin assembly 921 electrically connects to the first center pin assembly 911.

Before the first assembly 91 and the second assembly 92 abut each other, the first and second center pin assemblies have to be aligned first. However, the first assembly 91 and the second assembly 92 are fastened by screws 93, and the two center pin assemblies may be shifted due to uneven force or other factors, resulting in poor concentricity, which affects the transmission quality.

To overcome the shortcomings, the present invention provides a connector adaptor to mitigate or obviate the aforementioned problems.

### SUMMARY OF THE INVENTION

The main objective of the present invention is to provide a connector adaptor which is configured to be electrically connected to a circuit board, and can effectively prevent two center pin assemblies from shifting due to uneven force when locking the first assembly and the second assembly, thus preventing the transmission quality from being affected by the shifting.

For the above purpose, the present invention provides a connector adaptor, adapted to be electrically connected to a circuit board.

The connector adaptor comprises a first assembly, a second assembly, and multiple fixture elements. The first assembly comprises a first center pin assembly and a retaining structure. The first center pin assembly is mounted through the first assembly. The retaining structure is a chunk and comprises a first contact surface. The second assembly is connected to the first assembly and comprises a second center pin assembly and a first slot. The second center pin assembly is mounted through the second assembly and electrically connected to the first center pin assembly. The first slot corresponds to the retaining structure in shape and comprises a second contact surface. The second contact surface abuts the first contact surface. The first assembly and the second assembly are fastened by the fixture elements. The retaining structure is seated in the first slot, and thereby, the retaining structure cannot move along the second contact surface.

The advantage of the present invention is that the first assembly and the second assembly of the existing connector adaptor are changed, so that the first assembly and the second assembly form a concave-convex engaging relationship at their joints, and thereby the concave-convex engaging relationship limits the first assembly from translating relative to the second assembly. When the first assembly and the second assembly are fastened by fixture elements, the concave-convex engaging relationship prevents the two center pin assemblies from being pushed out due to uneven force resulting in shifting of the two center pin assemblies and affecting the transmission quality.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a connector adaptor in accordance with the present invention, shown with a circuit board;

FIG. 2 is a partial enlargement view of the connector adaptor in FIG. 1;

FIG. 3 is an exploded view of the connector adaptor in FIG. 1;

FIG. 4 is a sectional view of the connector adaptor in FIG. 1;

FIG. 5 is a sectional view of the connector adaptor in FIG. 1;

FIG. 6 is a sectional view of the connector adaptor on the circuit board in FIG. 1;

FIG. 7 is a side view of the first assembly of the connector adaptor in FIG. 1;

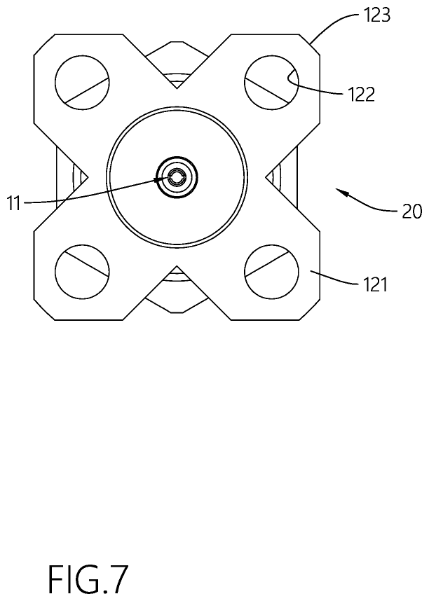

FIG. 8 is a side view of the second assembly of the connector adaptor in FIG. 1; and

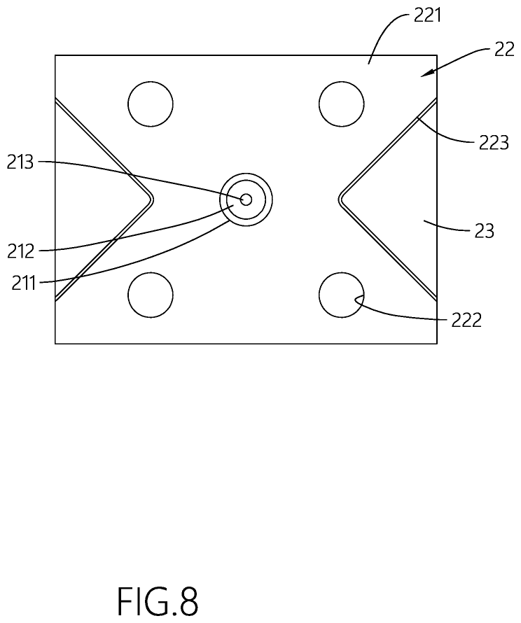

FIG. 9 is an exploded view in accordance with a conventional connector adaptor.

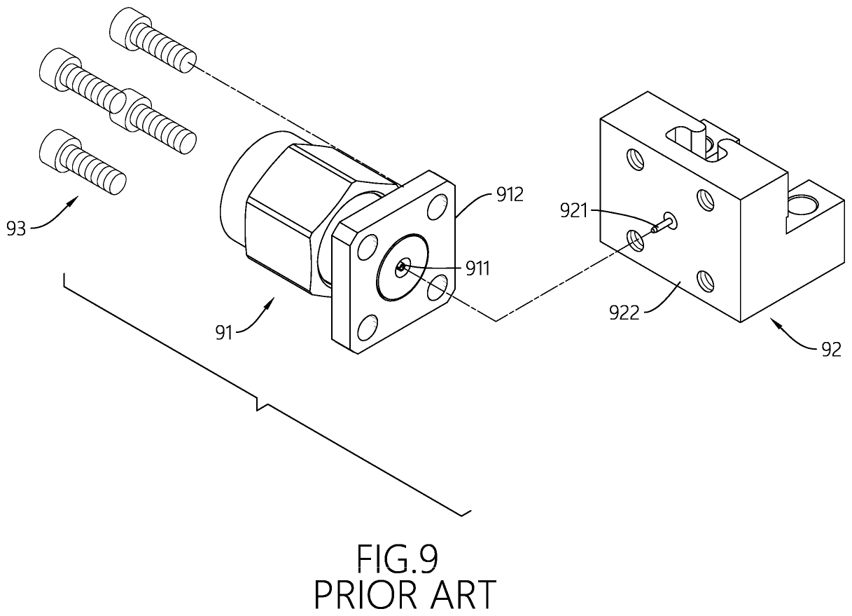

### DETAILED DESCRIPTION OF THE PREFERRED EMBODIMENTS

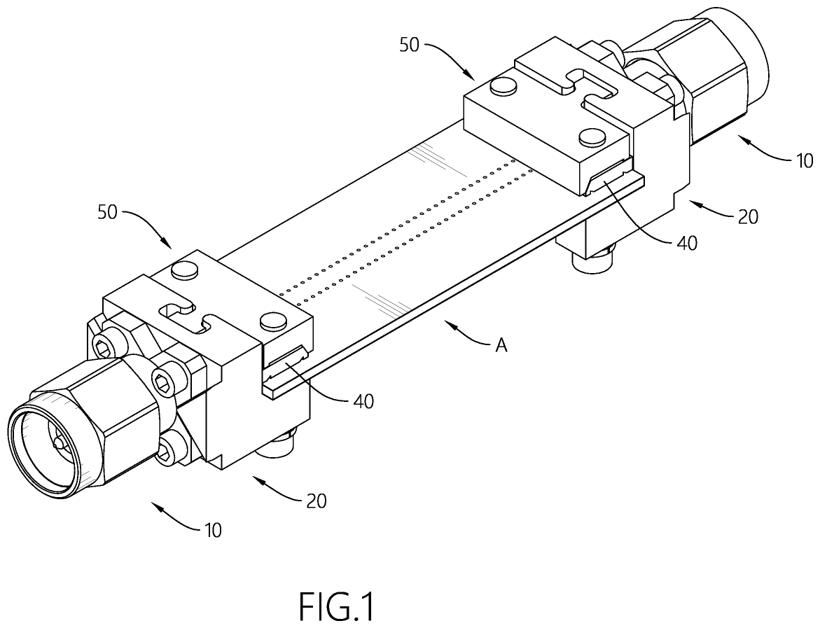

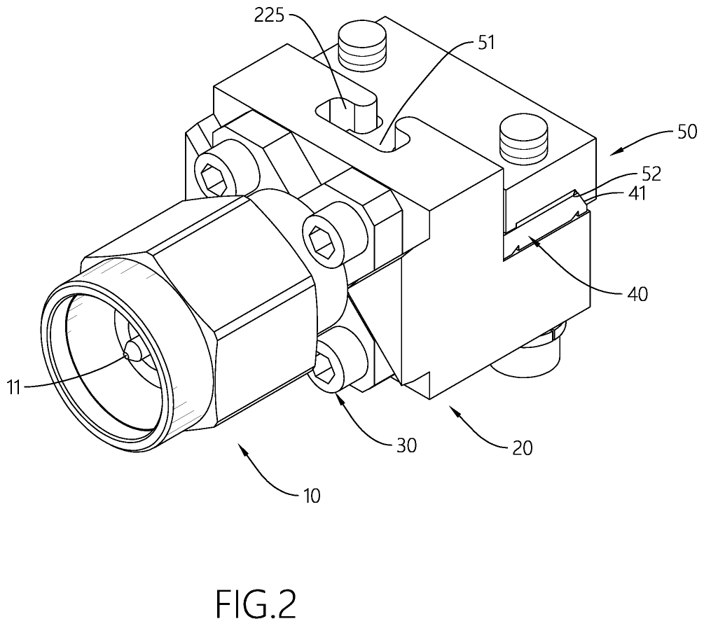

With reference to FIG. 1 and FIG. 2, the present invention provides a connector adaptor which is configured to be electrically connected to a circuit board A. The connector adaptor comprises a first assembly 10, a second assembly 20, and multiple fixture elements 30, and can selectively comprise a fixed board 40 and a locking board 50. Wherein, the second assembly 20 is electrically connected to the circuit board A.

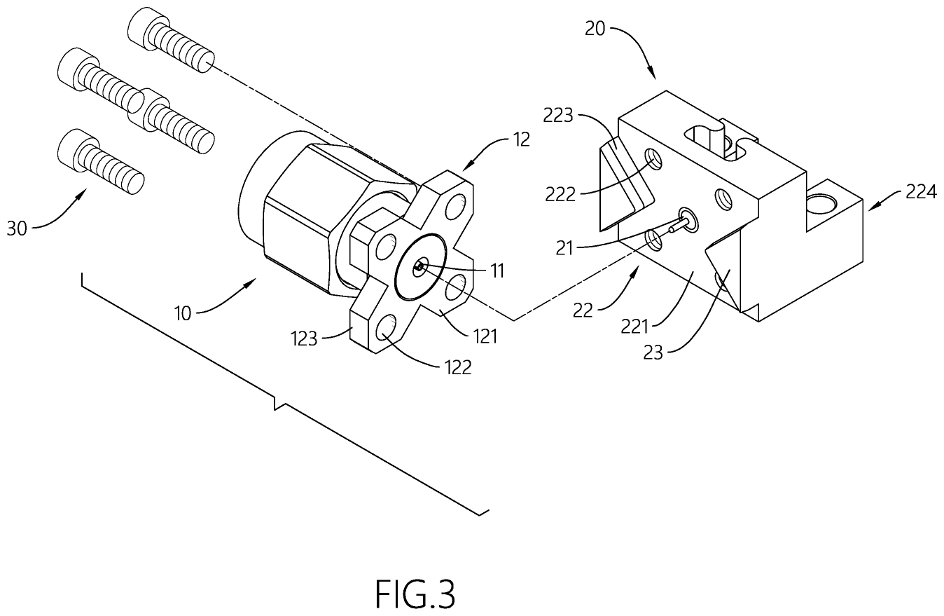

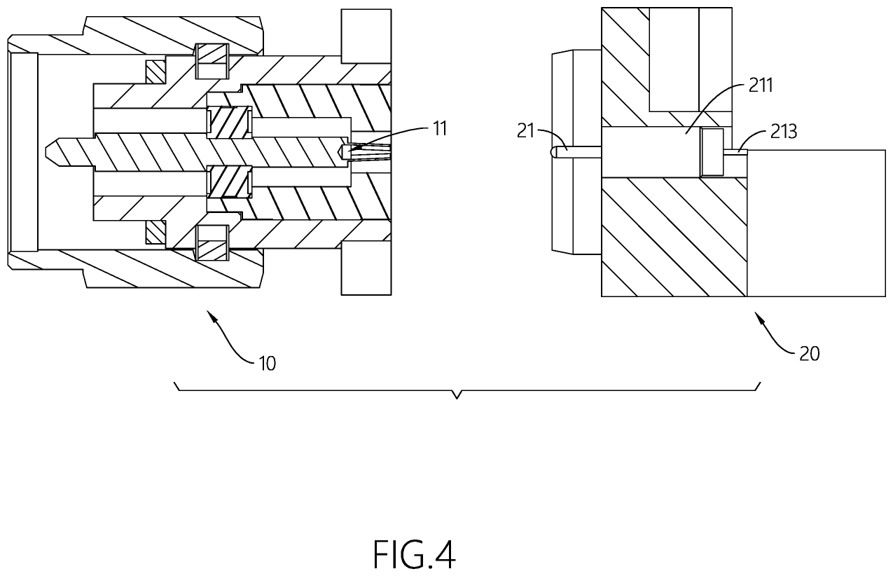

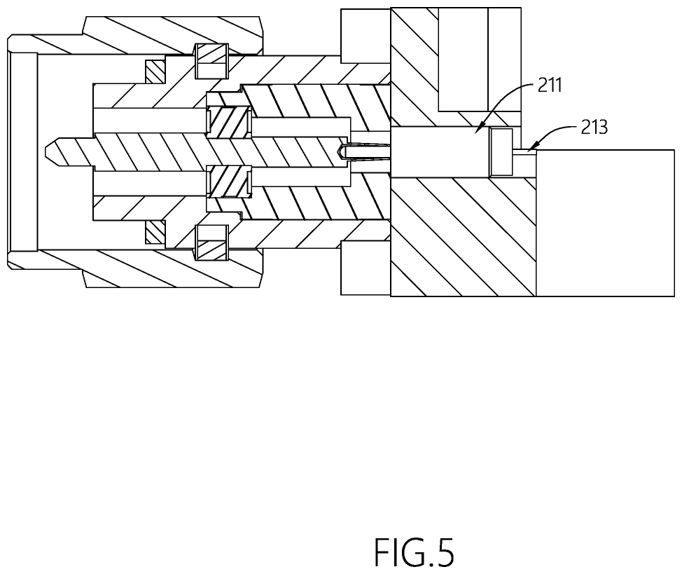

With reference to FIG. 3 to FIG. 5, the first assembly 10 comprises a first center pin assembly 11 and a retaining structure 12. The first center pin assembly is mounted through the first assembly 10. The retaining structure 12 is a chunk, and comprises a first contact surface 121, multiple apertures 122, and multiple first lateral edges 123. The apertures 122 are formed through the retaining structure 12 along an axis parallel to the first center pin assembly 11. The first lateral edges 123 are parallel to the axis of the first center pin assembly 11.

The second assembly 20 comprises a second center pin assembly 21 and a first slot 22. The second center pin assembly 21 is mounted through the second assembly 20 and electrically connected to the first center pin assembly 11. The second center pin assembly 21 comprises a metal tube 211, a rigid insulative layer 212, and a center pin 213. The metal tube 211 is mounted through the second assembly 20. The rigid insulative layer 212 is mounted in the metal tube 211, and the rigid insulative layer 212 contains hard insulating materials such as glass or ceramics. The center pin 213 is mounted in the rigid insulative layer 212. The rigid insulative layer 212 can reduce the deflection caused by extrusion of the center pin 213 when the center pin 213 is electrically connected to the circuit board A.

The first slot 22 comprises a second contact surface 211, multiple screw holes 222, and multiple second lateral edges 223. The second contact surface 211 can abut the first contact surface 121. In another embodiment, the concave-convex relationship between the first assembly 10 and the second assembly 20 may be reversed; in other words, the first assembly 10 comprises the first slot 22, and the second assembly 20 comprises the retaining structure 12. An opening of each one of the screw holes 222 is located on the second contact surface 211, and each one of the screw holes 222 corresponds to a respective one of the apertures 122. The second lateral edge 223 is parallel to the axis of the second center pin assembly 21, and the second lateral edge 223 and first lateral edge 123 abut each other.

The second assembly 20 may comprise two protruding sections 23, the first slot 22 is formed between the two protruding sections 23, and the second lateral edge 223 can be formed on the protruding sections 23. The retaining structure 12 of the first assembly 10 abuts the protruding sections 23. Therefore, when the retaining structure 12 is seated in the first slot 22, the retaining structure 12 cannot be moved along the direction of an imaginary extension line between the protruding sections 23. In another embodiment, the second assembly 20 may comprise four or more protruding sections 23, so that the retaining structure 12 is confined between the protruding sections 23.

The fixture elements 30 are mounted through and fastened to the apertures 122 and the screw holes 222, so that the first assembly 10 and the second assembly 20 abut each other.

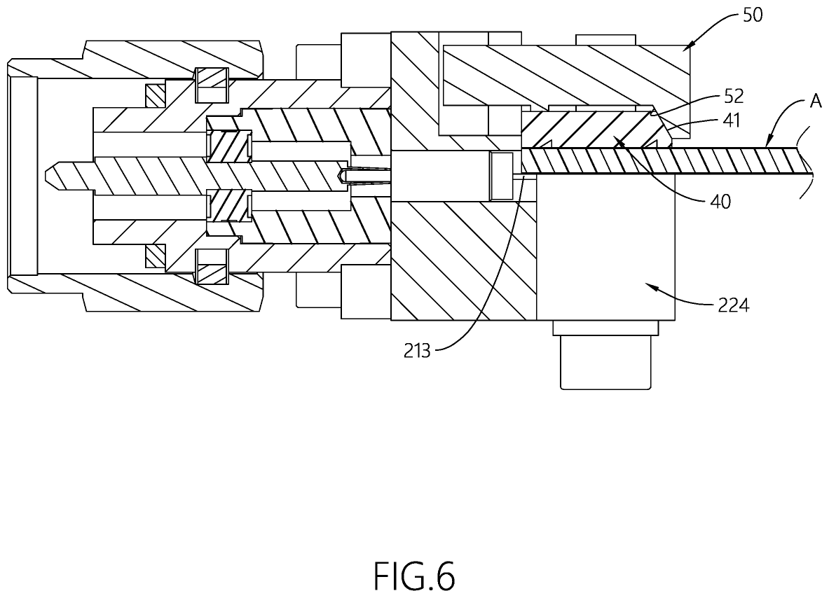

With reference to FIG. 6, in this embodiment, the second assembly 20 may comprise a conductive section 224 and a second slot 225, and the conductive section 224 and the first slot 22 are opposite to each other. A portion of the center pin 213 of the second center pin assembly 21 protruding from the rigid insulative layer 212 is located between the conductive section 224 and the circuit board A, and the center pin 213 of the second center pin assembly 21 abuts against the circuit board A.

In this embodiment, the connector adaptor comprises a fixed board 40 and a locking board 50. The portion of the center pin 213 protruding from the rigid insulative layer 212 and the circuit board A are located between the fixed board 40 and the conductive section 224. The fixed board 40 further comprises a first incline 41. The center pin 213, the circuit board A and the fixed board 40 are clamped between the locking board 50 and the conductive section 224. In other words, the above assemblies are arranged in the order of the locking board 50, the fixed board 40, the circuit board A, the center pin 213 and the conductive section 224.

The locking board 50 further comprises a block 51 and a second incline 52. The block 51 is embedded in the second slot 225. The second incline 52 corresponds to the first incline 41, and the first incline 41 abuts the second incline 52. By engaging the block 51 with the second slot 225 and by abutting the first incline 41 and the second incline 52, the locking board 50 can be guided to be mounted in the correct position when securing the locking board 50 to the second assembly 20.

In summary, the present invention alters the conventional first assembly 10 and second assembly 20 of the connector adaptor, so that the first assembly and the second assembly 20 form a concave-convex engaging relationship at their joints, and thus the concave-convex engaging relationship limits the first assembly 10 from translating relative to the second assembly 20. When the first assembly 10 and the second assembly 20 are fastened by the fixture elements 30, the concave-convex engaging relationship prevents the two center pin assemblies from being pushed out due to uneven force resulting in shifting of the two center pin assemblies and affecting the transmission quality. In addition, a concave and convex design of the present invention allows for quick positioning and saves assembly time.

On the other hand, the force exerted by the fixed board 40 and the locking board 50 when they are locked to the conductive section 224 may deform or deflect the circuit board A, such that the circuit board A pushes against the center pin 213. By changing the material of the rigid insulative layer 212 of the second center pin assembly 21, the present invention prevents the center pin 213 from shifting due to the center pin 213 abutting against the circuit board A, which affects the signal transmission.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A connector adaptor configured to be electrically connected to a circuit board, wherein the connector adaptor comprises:
a first assembly comprising:
a first center pin assembly mounted through the first assembly; and
a retaining structure being a chunk and comprising:
a first contact surface;
a second assembly connected to the first assembly and comprising:
a second center pin assembly mounted through the second assembly and electrically connected to the first center pin assembly; and
a first slot corresponding to the retaining structure in shape and comprising:
a second contact surface abutting the first contact surface;
multiple fixture elements fixing the first assembly and the second assembly; and
the retaining structure is seated in the first slot and thereby is unmovable along the second contact surface.

2. The connector adaptor as claimed in claim 1, wherein
the retaining structure comprises multiple apertures, and each one of the apertures is formed through the retaining structure; and
the first slot comprises multiple screw holes, an opening of each one of the screw holes is located on the second contact surface, and each one of the screw holes corresponds to a respective one of the apertures.

3. The connector adaptor as claimed in claim 1, wherein
the second assembly comprises two protruding sections, the first slot is formed between the two protruding sections, and the retaining structure of the first assembly abuts the two protruding sections.

4. The connector adaptor as claimed in claim 3, wherein
the retaining structure comprises multiple first lateral edges, and the multiple first lateral edges are parallel to an axis of the second center pin assembly;
the first slot comprises multiple second lateral edges, and the multiple second lateral edges are parallel to the axis of the second center pin assembly; and
the multiple first lateral edges and the multiple second lateral edges abut each other.

5. The connector adaptor as claimed in claim 1, wherein the second center pin assembly comprises:
a metal tube mounted through the second assembly;
a rigid insulative layer mounted in the metal tube; and
a center pin mounted in the rigid insulative layer.

6. The connector adaptor as claimed in claim 4, wherein the second center pin assembly comprises:
a metal tube mounted through the second assembly;
a rigid insulative layer mounted in the metal tube; and
a center pin mounted in the rigid insulative layer.

7. The connector adaptor as claimed in claim 5, wherein a material of the rigid insulative layer includes glass or ceramic.

8. The connector adaptor as claimed in claim 6, wherein a material of the rigid insulative layer includes glass or ceramic.

9. The connector adaptor as claimed in claim 5, wherein the second assembly further comprises a conductive section, the conductive section and the first slot are opposite to each other, the center pin is mounted between the conductive section and the circuit board, and the center pin abuts against the circuit board.

10. The connector adaptor as claimed in claim 8, wherein the second assembly further comprises a conductive section, the conductive section and the first slot are opposite to each other, the center pin is mounted between the conductive section and the circuit board, and the center pin abuts against the circuit board.

11. The connector adaptor as claimed in claim 9 further comprising a fixed board, and the center pin and the circuit board mounted between the fixed board and the conductive section.

12. The connector adaptor as claimed in claim 10 further comprising a fixed board, and the center pin and the circuit board mounted between the fixed board and the conductive section.

13. The connector adaptor as claimed in claim 11, wherein
the second assembly further comprises a second slot, and the second slot extends in a direction perpendicular to the center pin;
the connector adaptor further comprises a locking board, the locking board comprises a block, and the block is embedded in the second slot; and
the center pin, the circuit board, and the fixed board are clamped between the locking board and the conductive section.

14. The connector adaptor as claimed in claim 12, wherein
the second assembly further comprises a second slot, and the second slot extends in a direction perpendicular to the center pin;
the connector adaptor further comprises a locking board, the locking board comprises a block, and the block is embedded in the second slot; and
the center pin, the circuit board, and the fixed board are clamped between the locking board and the conductive section.

15. The connector adaptor as claimed in claim 13, wherein
the fixed board comprises a first incline, and the first incline is located on one side of the fixed board, said side of the fixed board being remote from the center pin;
the locking board comprises a second incline corresponding to the first incline; and
the first incline and the second incline abut each other.

16. The connector adaptor as claimed in claim 14, wherein
the fixed board comprises a first incline, and the first incline is located on one side of the fixed board, said side of the fixed board being remote from the center pin;
the locking board comprises a second incline corresponding to the first incline; and
the first incline and the second incline abut each other.
